(19) United States
(12) Patent Application Publication
(10) Pub. No.: US 2006/0149603 A1
(43) Pub. Date: Jul. 6, 2006

(54) Method and system for determining healthcare eligibility

(76) Inventors: Barbara Patterson, South San Francisco, CA (US); Stacy Pourfallah, Oakland, CA (US); Janet Pruitt, Mill Valley, CA (US); Loc Nguyen, San Francisco, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/230,743

(22) Filed: Sep. 20, 2005

Related U.S. Application Data
(60) Provisional application No. 60/641,483, filed on Jan. 4, 2005.
(60) Provisional application No. 60/641,464, filed on Jan. 4, 2005.
(60) Provisional application No. 60/641,597, filed on Jan. 4, 2005.

(51) Int. Cl. G06Q 40/00

(52) U.S. Cl. 705/4

(57) ABSTRACT

A method for determining healthcare insurance coverage eligibility is disclosed. The method includes receiving patient information at a terminal operated by a healthcare provider. An eligibility authorization request message is created, and is sent to an acquirer processor, where the acquirer processor sends the eligibility authorization request message to a transaction processing system, which routes the eligibility authorization request message to a healthcare processor. A response message is then received.

### CROSS-REFERENCES TO RELATED APPLICATIONS

This application is a non-provisional of and claims priority to the following U.S. provisional patent applications, which are incorporated by reference in their entirety for all purposes.
Application No. 60/641,483, filed Jan. 4, 2005, entitled “Method and System for Determining Healthcare Eligibility”;
Application No. 60/641,597, filed Jan. 4, 2005, entitled “Auto Adjudication for Over-the-Counter Transactions”; and
Application No. 60/641,464, filed Jan. 4, 2005, entitled “Method for Encoding Messages Between Two Devices for Transmission Over Standard Online Payment Networks”.

### BACKGROUND OF THE INVENTION

Insurance companies typically provide their customers with health identification (ID) cards, which contain information such as patient name, employer plan number, type of insurance coverage, and applicable co-pay amounts. These ID cards are useful to healthcare providers such as doctors.

While ID cards are useful, they do not convey information regarding the current status of insurance coverage. For example, the cardholder may no longer be employed by the company that originally provided insurance coverage, so that the cardholder's insurance coverage may no longer be valid. To deal with this issue, healthcare providers use different means to check the current eligibility status of patients.

Some providers fax and/or make telephone calls to a customer service center operated by the cardholder's insurance carrier to determine if the cardholder is eligible for a particular type of healthcare service. Such methods, however, can be time consuming for the provider's office staff and are expensive for insurance carriers.

Some companies (e.g., SpotCheck and ProxyMed) have developed electronic eligibility verification systems using point-of-sale (POS) terminals. The POS terminals require either a dedicated POS terminal or separate connections to the eligibility service provider. Such systems require the use of specialized POS terminals and specialized connections between the service provider and the carrier. Since specialized equipment is required, widespread acceptance of such systems has not been achieved.

Some companies (e.g., United Health Group and MasterCard) have developed electronic eligibility verification using a POS terminal and a payment authorization transaction over an existing payment network, where the transaction amount is used to equate to a particular service type (e.g., $0.01 is an office visit). This approach has created problems for the provider's office and the provider's financial institution, because these transactions are indistinguishable from a true payment transaction and can be inadvertently processed as real payment transactions.

Some healthcare clearing houses (e.g. WebMD) and insurance companies have developed Internet-based systems to permit provider offices to access eligibility information electronically, but this typically requires relatively expensive PC equipment and PC-trained office staff. As noted above, if specialized equipment is required, widespread acceptance is unlikely.

Embodiments of the invention address these and other problems.

### SUMMARY OF THE INVENTION

Embodiments of the invention are directed to methods, apparatuses, and systems for facilitating communication in a healthcare environment.

One embodiment of the invention is directed to a method comprising: receiving patient information at a POS terminal operated by a healthcare provider; creating a non-financial authorization request message which relates to healthcare using payment card and patient information; sending the authorization request message to an acquirer processor, wherein the acquirer processor sends the authorization request message to a transaction processing system such as a payment processing system, and wherein the authorization request message is evaluated (e.g., by an insurance company) in view of information from a healthcare processor; and receiving a response message in response to the authorization request message.

Another embodiment of the invention is directed to a computer readable medium comprising: code for receiving patient information at a terminal operated by a healthcare provider; code for creating a non-financial authorization request message which relates to healthcare using the patient information; code for sending the authorization request message to an acquirer processor, wherein the acquirer processor sends the authorization request message to a transaction processing system, and wherein the authorization request message is evaluated (e.g., by an insurance company) in view of information from a healthcare processor or an issuer processor; and code for receiving a response message in response to the authorization request message.

Another embodiment of the invention is directed to a method comprising: receiving patient information comprising a patient identification number at a terminal operated by a healthcare provider, wherein the patient information is stored in a portable consumer device in the form of a card; creating a non-financial authorization request message, which relates to healthcare using the patient information, wherein creating the authorization request message comprises adding data to a data field to indicate that the authorization request message relates to a non-financial transaction; sending the authorization request message to an acquirer processor, wherein the acquirer processor sends the authorization request message to a transaction processing system, an issuer processor, and (optionally) then a healthcare processor; and receiving a response message from the healthcare processor, via the issuer processor, the transaction processing system, and the acquirer processor.

These and other embodiments of the invention are described in further detail below.

### BRIEF DESCRIPTION OF THE DRAWINGS

FIG. 1 shows a block diagram of a system according to an embodiment of the invention.

FIG. 2 shows a flowchart showing steps in a process according to an embodiment of the invention.

FIGS. 3(a)-3(d) show a flowchart illustrating steps in an eligibility determination process according to an embodiment of the invention.

### DETAILED DESCRIPTION

Embodiments of the invention solve the problems of conventional health information systems by enabling healthcare providers to electronically check the eligibility status of patients via simple POS terminals connecting over existing payment system networks using an eligibility-specific information transaction, not a payment authorization transaction. Specialized equipment is not required in embodiments of the invention, so widespread acceptance is much more likely than systems that require the use of specialized hardware and/or communications equipment. Embodiments of the invention send non-financial healthcare related messages through an existing financial network. Since the messages are not financial in nature, the acquirers, the providers and the insurance carriers will not confuse financial transaction messages passing through the network with the non-financial healthcare related messages. These and other advantages provided by embodiments of the invention are apparent from the following descriptions of embodiments of the invention.

In embodiments of the invention, a patient's eligibility to status regarding healthcare insurance coverage for healthcare related good or service is determined. The healthcare related good or service can be provided by a healthcare provider, and the eligibility determination is made by an adjudication entity such as an insurance carrier. Examples of healthcare providers include doctors, dentists, eye care specialists, hospitals, laboratories, stores that sell healthcare related goods, injury clinics, etc.

Several types of eligibility responses are possible in embodiments of the invention. These include a basic eligibility response, a basic eligibility with co-pay response, and an enhanced eligibility response. Each of these types of eligibility responses is described in further detail below.

Basic Eligibility Response: The basic eligibility response message includes information regarding whether the patient is eligible for healthcare coverage. For example, a basic eligibility response may simply be a “Yes/No” type of response.

Basic Eligibility with Co-Pay Response: The basic eligibility with co-pay response provides more information than the basic eligibility response. For example, in addition to a basic eligibility response message, the healthcare insurance carrier may provide information regarding a required co-pay amount. This helps to avoid problems when the patient does not remember or know the appropriate co-pay amount associated with the desired healthcare related good or service. In this case, both the eligibility status and co-pay amount are returned to the provider and/or the patient in a response message.

Enhanced Eligibility Response: An enhanced eligibility response may also have more information than the basic eligibility response. For example, to support new trends in consumer-driven healthcare, healthcare insurance carriers may provide additional information regarding the plan type, plan contracted service amount, family or individual coverage, deductibles, co-insurance, co-pay amounts, etc. Examples of enhanced eligibility responses are provided below.

In an illustrative embodiment of the invention, a patient can swipe a payment card or health card at a healthcare provider's POS terminal. If a payment card is used, the card numbers are standard payment system card numbers issued in conformance with payment system standards.

The transaction can be formatted by or at the POS terminal using the acquirer's-defined transaction type format for information transactions. A processing code may be entered (manually or automatically) into the POS terminal to indicate that the transaction is a non-financial eligibility request transaction. The created authorization request message is then forwarded to the provider's acquirer processor, through an International Standards Organization (ISO) payment transaction system (e.g., Visanet), and to a designated issuer processor. The transmissions between the various entities in the system may be completed in HIPAA-compliant manner (Health Insurance Portability and Accountability Act of 1996), both in format of the message and security requirements.

The issuer, or its designated processor, identifies the transaction as a healthcare eligility verification request. It then converts the patient's card number into the health insurance carrier's identification number for that individual. The issuer processor may then optionally forward the authorization request message (e.g., an eligibility authorization request message) to a healthcare processor.

The healthcare processor then determines if the patient is eligible or not for healthcare insurance coverage. The insurance carrier (or an entity designated by the insurance carrier) who operates the healthcare processor checks the current eligibility status for the individual's identification number and responds with a status of “Yes,” currently eligible for healthcare insurance coverage or “No,” not currently eligible. Alternatively, if there is a more complicated eligibility issue to be resolved, then the healthcare provider may be requested to contact the insurance carrier. Additional information, such as the co-pay amount, may also be included in a response message.

Once a response message is created, the healthcare or issuer processor transmits the response message including the eligibility determination back to the provider's POS terminal. The response message can be returned through the same path that the authorization request message (e.g., eligibility authorization request message) traveled, using appropriate message formats at each point in the process. Once the POS terminal receives the response message, the eligibility response information is then printed by the POS terminal and/or displayed at the POS terminal.

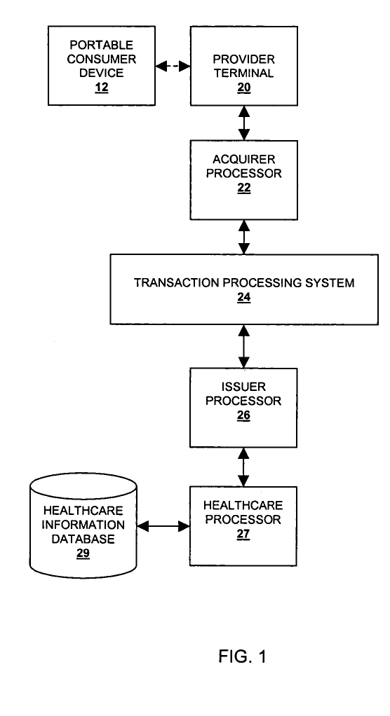

FIG. 1 shows a block diagram for a healthcare system according to an embodiment of the invention. The system includes a provider terminal 20 that is operated by a healthcare provider. The terminal 20 may be a POS (point of sale) terminal like those that are presently available to interact with ordinary payment cards. In FIG. 1, one terminal 20 and one provider are described for simplicity of illustration. It is understood that there may be many more terminals and many more providers in embodiments of the invention.

The terminal 20 may interact with portable consumer device 12. Examples of portable consumer devices include credit cards, debit cards, prepaid cards, healthcare insurance cards, smartcards, radio frequency identification (RFID) devices, driver's licenses, personal digital assistants, ATM cards, security badges, access badges, stored value cards, pagers, and the like. Interaction between the terminal 20 and the portable consumer device 12 can be facilitated using any suitable optical, magnetic, electromagnetic, or electronic mechanism. In some embodiments, the portable consumer device 12 is in the form of a card and has a magnetic stripe.

The portable consumer device 12 may store or display information such as BINs (bank identification numbers), card account number, patient name, patient healthcare number, birth date, card expiration date, employer name, employer/group policy number, dependent names/numbers, co-payment amounts, etc.

The terminal 20 is in communication with an acquirer processor 22, which may be operated by an acquiring financial institution or by a third party processor on behalf of the acquiring financial institution. The acquiring financial institution may also process transactions for other merchants or sellers. The acquirer processor 22 is used to conduct ordinary financial transactions, and thus may be in communication with other merchants or sellers and processors.

The acquirer processor 22 communicates with an issuer processor 26 via a transaction processing system 24. The transaction processing system 24 can be primarily used for processing financial transactions. It can facilitate transactions that occur between the acquirer processor 22 and the issuer processor 26. The transaction processing system 24 can be operated by an organization such as a credit or debit card company.

The issuer processor 26 may be operated by an issuing financial institution such as a buyer bank, or another third party processor on behalf of the card issuer. A buyer (not shown) may interact with the issuer processor 26. The buyer may or may not be a healthcare consumer. In embodiments of the invention, non-healthcare related buyers and sellers can use the same system as healthcare related buyers (e.g., patients) and sellers (e.g., service providers such as doctors).

The issuer processor 26 may further be in communication with a healthcare processor 27, which may be operated by an entity such as an insurance carrier or a third party processor that it designates. A healthcare database 29 may be in communication with the healthcare processor 27. The healthcare database 29 may store information such as patient information, provider information, insurance plan information, service code information, etc. Alternatively, the healthcare database may be operated by the issuer processor or a third party processor on behalf of the issuer.

The various processors shown in FIG. 1 (e.g., acquirer processor) may be embodied by any suitable combination of hardware and/or software. Typically, each processor includes at least a server computer. A server computer is a powerful computer or cluster of computers that behaves as a single computer which, services the requests of one or more client computers. The server computer can be a mainframe computer, a minicomputer, or a minicomputer cluster. For example, the server computer may include one or more database servers and one or more Web servers. Software for performing any of the functions of the processors (or any of the functions described herein) may be embodied by computer code stored on a computer readable medium, which may store data using suitable electrical, electroptical, optical, or magnetic data storage mechanism. The computer code may be written in any suitable programming language including C, C++, Pascal, etc.

Also, the system shown in FIG. 1 may be implemented using existing private networks or specialized communication networks (e.g., the Internet). The communication links may also include wired or wireless links.

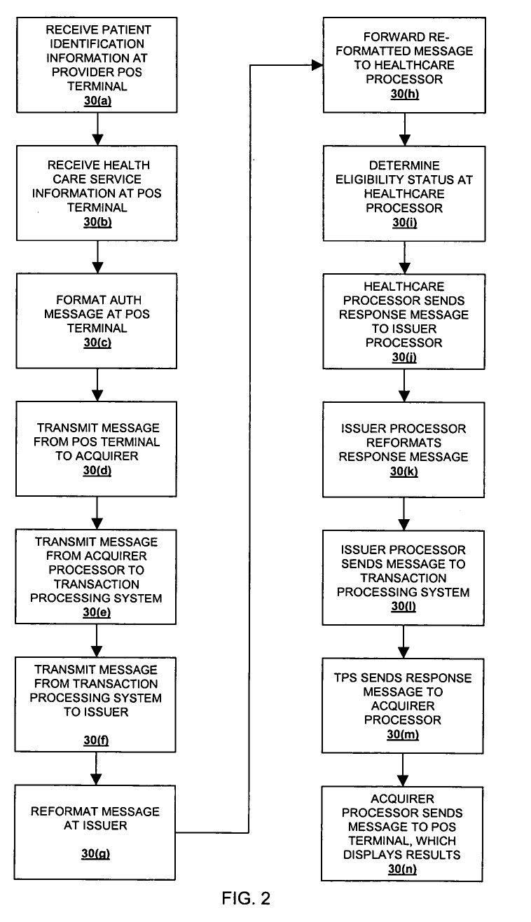

More specific methods according to an embodiment of the invention may be described with reference to FIG. 2, while also referring to FIG. 1.

First, patient identification information is received at a provider terminal 20 (step 30(a)). In some embodiments, the patient may use a portable consumer device 12 to provide patient identification information or other information to the provider terminal 20. For example, the POS terminal transaction is originated like any other payment card transaction. The patient may have a payment (credit, debit or prepaid/stored value) or healthcare card with a magnetic stripe. The magnetic striped card is swiped through a card reader in the provider's terminal 20. Examples of patient identification information include credit, debit, or prepaid/stored value card numbers, health identification numbers, birth date, dependent names/numbers, social security numbers, drivers license numbers, etc.

Before or after the patient identification information is provided to the provider terminal 20, the provider (or the patient) may provide healthcare service information to the terminal 20. A processing code may be entered (manually or automatically) into the POS terminal to indicate that the transaction is a non-financial eligibility transaction. For example, a processing code for a healthcare related, non-financial message might be indicated as “39” (or any other code), while a processing code for purchasing a good or service might be indicated by the code “00”.

In another example, service codes can be entered into the terminal 20. For example, provider staff can follow specified procedures, including entry of the healthcare-defined service type codes. These codes may be entered into the terminal 20 manually (e.g., by using input keys) or may be entered automatically. In other embodiments, instead or in addition to healthcare services, healthcare goods information (e.g., SKU numbers) may be input into the terminal 20.

There are a number of healthcare service codes. Some examples are as follows:

| Service Code | Definition |
|---|---|
| 1 | Medical Care |
| 2 | Surgical |
| 50 | Hospital - Outpatient |
| 68 | Well Baby Care |
| 86 | Emergency Services |
| 98 | Physician Office Visit |
| A1 | Physician Visit Nursing Home |
| AL | Vision (Optometry) |

After the patient information and the healthcare information are entered into and received by the terminal 20, an authorization request message (e.g., an eligibility authorization request message) may then be formatted at the terminal 20 (step 30(c)). The authorization request message may be formatted in a format specified by the acquirer or as an International Standards Organization (ISO) type, non-financial, information message. In some cases, the authorization request message may be an ISO 8583 type message, such as a standard (VisaNet) authorization request message. Information that may be included in the authorization request message is shown in the following table.

| Data Element | Description | Length |
|---|---|---|
| Card Number | The card number assigned by the | 16 |
| | issuing financial. | (Numeric) |
| Healthcare Provider | The medical license number of | 9 |
| ID | provider. | (Numeric) |
| Service Type Code | A healthcare-defined standard code for | 5 (Alpha- |
| | healthcare treatment. | numeric) |

In some embodiments, data such as eligibility data associated with the patient may be added to a discretionary data field in the authorization request message. A discretionary data field is a field that can contain any particular information desired, for example, by an issuer. Additionally, discretionary data fields may be present in various data “tracks” that are present in many commercial credit and debit cards. Such data formats are defined by ANSI (American National Standards Institute).

Once formatted, the authorization request message may then be transmitted from the terminal 20 to the acquirer processor 22 (step 30(d)). The acquirer processor 22 then forwards the authorization request message to the transaction processing system 24 (e.g., VisaNet) (or “TPS”) (step 30(e)).

The transaction processing system 24 (e.g., VisaNet) then forwards the authorization request message to the designated issuer processor 26 (step 30(f)). A bank identification number (BIN), which is the first six digits of the card number, may be used to facilitate routing to the issuer, or its designated processor 26.

After receiving the authorization request message associated with the specified BIN, the issuer processor 26 uses a number of data fields to identify an eligibility request (processing code and BIN) and converts the card number (e.g., a payment card number) to the insurance carrier's identification number for that patient (step 30(g)). The re-formatted message is then forwarded to the healthcare processor 27 (step 30(h)), which may be operated by an issuer processor or an insurance carrier, other payor, or other designated third party processor. The message format between the issuer processor 26 and healthcare processor 29 can be any mutually agreed format.

The authorization request message is evaluated in view of information from the healthcare processor 27. In other words, the eligibility determination can be made by the healthcare processor 27 or with information that is provided by the healthcare processor 27. For example, after receiving the authorization request message associated with the patient's identification number, the healthcare processor 27 checks the current eligibility status for the patient (step 30(i)). Patient data may be stored in the healthcare information database 29 and the healthcare processor 27 may contact the healthcare database 29 to determine if the patient is eligible for the requested healthcare-related good or service. The healthcare processor 27 then generates and sends a “yes” or “no” response back to the terminal 20, patient and provider. If approved and if applicable, the healthcare processor 27 also forwards the required co-pay for that service type code for the patient's plan coverage. More specific descriptions of eligibility determination processes performed by the healthcare processor 27 are provided below.

Any suitable response message format may be used. For example, the data to be transmitted from the healthcare processor 27 back to the terminal 20 may be formatted in a standard ISO type authorization response at some point in the process. An exemplary authorization response may include the following:

| Data Element | Description | Length |
|---|---|---|
| Card Number | The card number assigned by the issuing | 16 |
| | financial institution. | (Numeric) |
| Healthcare | A medical license number of provider. | 9 |
| Provider ID | | (Numeric) |
| Service Type | A healthcare-defined standard code for | 5 (Alpha- |
| Code | healthcare treatment. | numeric) |
| Carrier ID | An identification number that identifies the | 6 |
| | health insurance carrier or payer. | (Numeric) |
| Approval | Healthcare-defined codes for approvals and | 2 (Alpha- |
| or Reject | rejections of eligibility inquiries (see | numeric) |
| Reason Code | below). | |
| Co-Pay | The amount of the co-pay, if applicable. | 10 |
| Amount | | (Numeric) |
| Carrier | Carrier defined comments or information. | Up to 200 |
| Comments | | (Alpha- |
| | | numeric) |

There are a number of healthcare-defined codes for rejected requests. Some examples are as follows.

| Reject Code | Definition |
|---|---|
| 15 | Required application data missing |
| 42 | Unable to respond at current time |
| 43 | Invalid/Missing provider identification |
| 52 | Service dates not within provider plan environment |
| 67 | Patient not found |

The response message may be sent from the issuer processor 26 to the terminal 20 along the path through which the authorization request message was transmitted. For example, the healthcare processor 27 sends the response message to the issuer processor 26 (step 30(j)). Upon receiving the response message, the issuer processor 26 converts the insurance carrier's identification number back to the patient's card number (e.g., payment card number) and maps the approval code and co-pay amounts into the designated fields of the authorization response message (step 30(k)). The authorization response message is then sent to the transaction processing system 24 (step 30(l)), and the transaction processing system 24 sends the authorization request message to the acquirer processor 22 (step 30(m)). The acquirer processor 22 then sends the response message to the originating terminal 20 (step 30(n)).

After the request message is received at the terminal 20, the terminal 20 may display or print out the response message. If the response indicates an approval, the terminal 20 may print a receipt that shows the co-pay information and any additional text returned by the healthcare processor 27. If the eligibility status cannot be confirmed, a decline response will be displayed on the receipt and additional manual verification procedures may be needed.

Embodiments of the invention are not limited to the steps shown in FIG. 2. For example, the eligibility determination need not be performed by the healthcare processor 27. In other embodiments, carrier and patient information can be sent from the healthcare processor 27 to the issuer processor 26, the transaction processing system 24, and/or the acquirer processor 22. The issuer processor 26, the transaction processing system 24, and/or the acquirer processor 22 could then make the eligibility determination based on information received from the healthcare processor 27.

Exemplary Eligibility Determination Processes

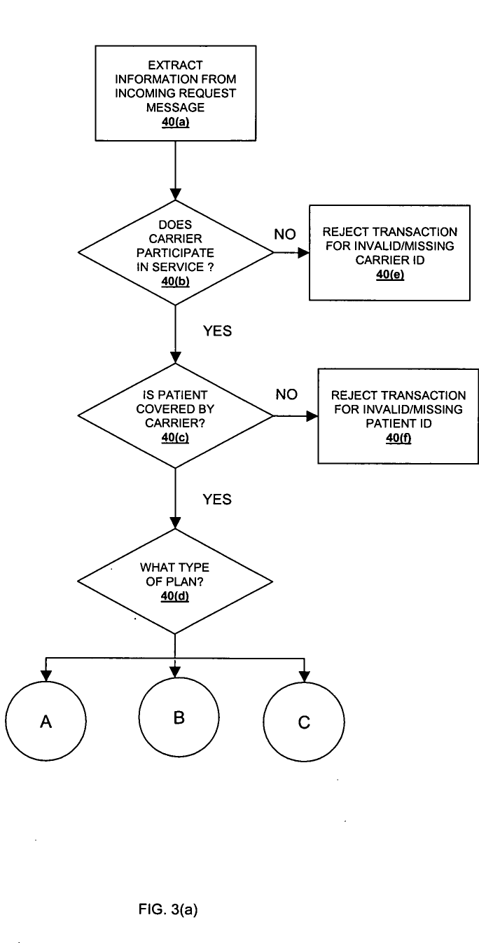

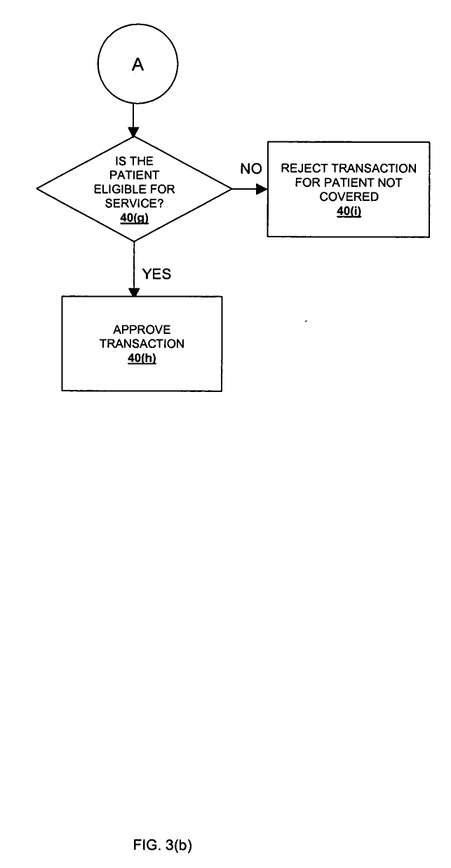

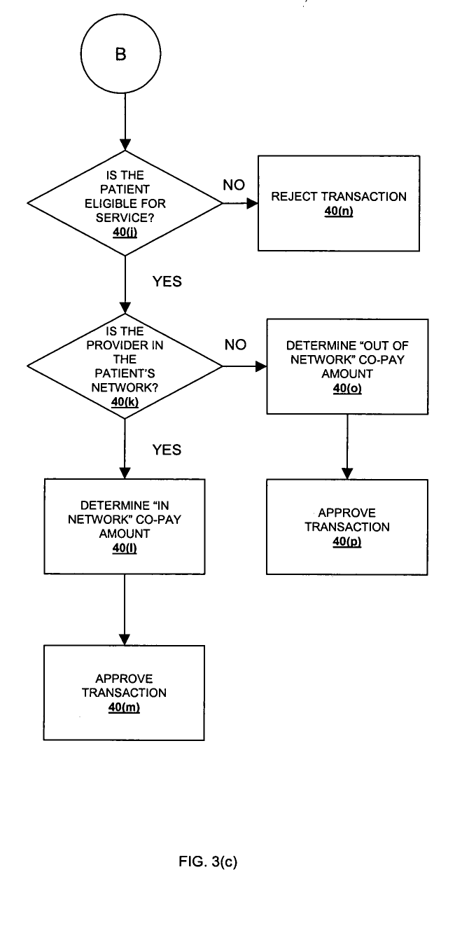

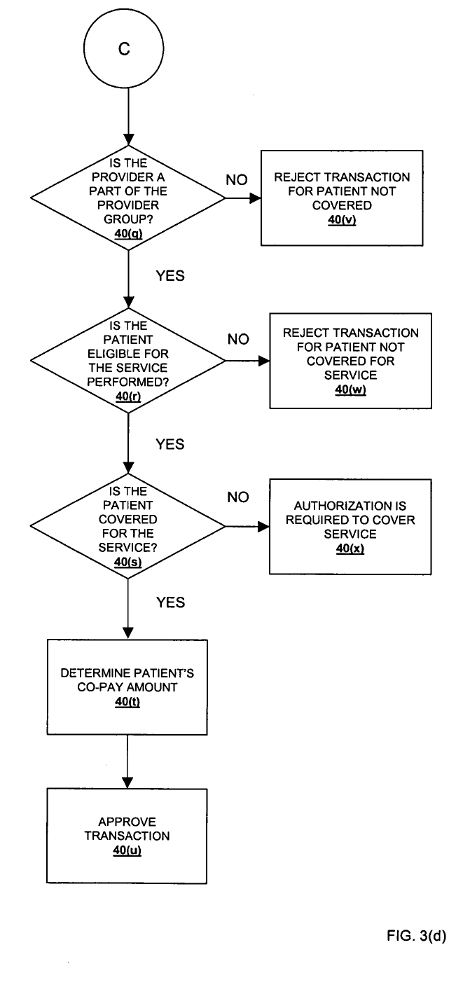

The examples described above illustrate methods that employ basic eligibility determinations. FIGS. 3(a) to 3(d) show a flowchart illustrating steps in a more complicated eligibility determination process that can be performed by the healthcare processor 27 (or other entity).

Referring to FIG. 3(a), the healthcare processor 27 extracts patient identification information from the authorization request message (step 40(a)), and then determines whether or not the carrier participates (step 40(b)). The patient identification information in the authorization request message is compared to patient identification data in the healthcare information database 29. As shown at decision step 40(c), if the patient identification information is matched to appropriate information in the healthcare database 29, then the transaction proceeds to the next step 40(c). As shown at step 40(e), if the patient information cannot be matched to information in the healthcare database 29, then the transaction is rejected. A response message with a reject reason code (e.g., “code 90: invalid/missing payor ID”) is created by the healthcare processor 27.

If the healthcare processor 27 determines that the patient is covered by the insurance carrier, then the healthcare processor 27 determines what type of plan covers the patient (step 40(d)). If the patient has an indemnity plan type, then the process proceeds to the indemnity insurance plan subroutine A. If the patient has a POS (point of service) plan type, then the process proceeds to the POS insurance plan subroutine B. If the patient has an HMO or PPO plan type, then the process proceeds to the HMO/PPO insurance plan subroutine C.

FIG. 3(b) shows a subroutine that is applicable if the patient is covered under an indemnity insurance plan. First, the healthcare processor 27 determines if the patient is eligible for service (step 40(g)). If the patient is not covered, then the transaction is rejected by the healthcare processor 27. If the patient is covered, the healthcare processor 27 approves of the transaction (step 40(h)).

FIG. 3(c) shows a subroutine that is applicable if the patient is covered under a POS insurance plan. The healthcare processor 27 determines if the patient is eligible for the healthcare related good or service (step 40(j)). If the patient is not eligible, the transaction is rejected (step 40(n)). If the patient is eligible, then the healthcare processor 27 determines if the provider is in the patient's network (step 40(k)). If the patient is not eligible, then the healthcare processor 27 determines an “out of network” co-pay amount (step 40(o)), and the transaction is approved (step 40(p)). If the provider is in the patient's network, then the “in network” co-pay amount is determined (step 40(l)), and the transaction is approved (step 40(m)).

FIG. 3(d) shows a subroutine that is applicable if the patient is covered under an HMO or PPO plan type. First, the healthcare processor 27 determines if the provider is part of the provider group (step 40(q)). If the provider is not part of the HMO/PPO provider group, then the transaction is rejected and a message indicating that the patient is not covered is sent from the healthcare processor 27 back to the provider's terminal 20.

If the provider is part of the provider group, then the healthcare processor 27 determines if the patient is eligible for the service performed (step 40(r)). If not, then the transaction is rejected and a message indicating that the patient is not covered is sent from the healthcare processor 27 back to the provider's terminal 20.

If the patient is eligible for the healthcare related good or service, then the healthcare processor 27 determines if the patient is covered by the service (step 40(s)). If not, then the healthcare processor 27 seeks authorization to cover the service (step 40(x)). If the patient is eligible, then the patient's co-pay amount is determined and the transaction is approved (step 40(u)).

Enhanced Eligibility Transactions

The specific embodiments described above refer to transactions where the eligibility of the patient is determined. Other embodiments of the invention can be used for “enhanced eligibility transactions”. There is a growing trend in the delivery of healthcare for individuals to assume a greater role for the payment of services. It is thought that consumers will exercise greater care, and be more cost conscious, in the purchase of healthcare services if they are responsible for directly paying for a greater proportion of their healthcare expenditures. This trend is referred to as consumer-driven or consumer-directed health care (CDHC). The advent of Health Savings Account (HSA) in December 2003 to complement high deductible health plans was a major step in the direction of CDHC. With high deductible health plans, individuals have much more discretion, and a greater stake, in the cost of healthcare services—as they will be paying 100% of the expenses up to the deductible amount of their health plan.

Health Savings Accounts offered individuals covered by high deductible health plans an opportunity to save on a tax-advantaged (applies to federal income taxes and may or may not apply to state income taxes) an amount up to the deductible of the health plan.

With this in mind, the healthcare provider potentially faces a more complicated situation in knowing how much to collect from the patient at the time of the visit. To give providers more information, the following data elements may be added in the authorization response message:

| Data Element | Description | Length |
|---|---|---|
| Card Number | The card number assigned by the issuing | 16 |
| | financial institution. | (Numeric) |
| Healthcare | The medical license number of provider. | 9 |
| Provider ID | | (Numeric) |
| Service | A healthcare-defined standard code for | 5 (Alpha- |
| Type Code | healthcare treatment. | numeric) |
| Carrier | An identification number that identifies the | 6 |
| ID | health insurance carrier. | (Numeric) |
| Approval | healthcare-defined codes for approval and | 2 (Alpha- |
| or Reject | declines of eligibility inquiries. | numeric) |
| Reason Code | | |
| Co-Pay | The amount of the co-pay, if applicable. | 10 |
| Amount | | (Numeric) |
| Insurance | A code identifying the type of insurance | 3 (Alpha- |
| Type Code | policy within a specific insurance program | numeric) |
| | (e.g., “hm” for health maintenance | |
| | organization, “mc” for Medicaid, “wc” for | |
| | workers compensation). | |
| Coverage | A code indicating the level of coverage | 3 |
| Level Code | being provided for the patient, such as | (Alpha- |
| | “employee only” , “family”, etc. | numeric) |
| Contracted | The contracted amount for the service type | 12 |
| Service | code which the provider has agreed to | (Numeric) |
| Amount | accept. | |
| Remaining | The remaining amount of the deductible | 12 |
| Deductible | which the insured individual has to meet | (Numeric) |
| Amount | before the carrier will reimburse the | |
| | provider. | |

Information such as this may assist a provider in knowing a contracted amount to charge for services under the patient's healthcare plan, and whether to collect from the patient, because the deductible amount has not been met and/or collect any co-pay amounts.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

Also, it should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software. For example, although separate issuer and acquirer processors are shown in the Figures, a single processor may satisfy the functions performed by separate issuer and acquirer processors in other embodiments of the invention.

All references, patent applications, and patents mentioned above are herein incorporated by reference in their entirety for all purposes. None of them are admitted to be prior art to the presently claimed inventions.

What is claimed is:

1. A method comprising:
receiving patient information at a terminal operated by a healthcare provider;
creating a non-financial eligibility authorization request message which relates to healthcare insurance coverage using the patient information;
sending the eligibility authorization request message to an acquirer processor or its designated third party processor, wherein the acquirer processor sends the authorization request message to a transaction processing system, and wherein the authorization request message is evaluated in view of information from an issuer processor or a healthcare processor; and
receiving a response message in response to the eligibility authorization request message.

2. The method of claim 1 wherein the eligibility authorization request message is routed from the transaction processing system to the healthcare processor via the issuer processor.

3. The method of claim 1 wherein creating the authorization request message comprises adding data to a data field to indicate that the authorization request message relates to a non-financial eligibility request transaction.

4. The method of claim 1 wherein the healthcare processor is operated by an insurance carrier, the issuer processor or a third-party processor.

5. The method of claim 1 wherein the response message relates to whether or not the patient is eligible for a healthcare related good or service.

6. The method of claim 1 wherein the patient information is at least in part obtained from a portable consumer device, wherein the portable consumer device is in the form of a card or other portable consumer device.

7. The method of claim 1 further comprising receiving a service code at the terminal.

8. The method of claim 1 wherein the transaction processing system is part of a payment processing network.

9. The method of claim 1 further comprising displaying or printing information relating to the response message at the terminal.

10. A computer readable medium comprising:
code for receiving patient information at a terminal operated by a healthcare provider;
code for creating a non-financial eligibility authorization request message which relates to healthcare insurance coverage using the patient information;
code for sending the eligibility authorization request message to an acquirer processor, wherein the acquirer processor sends the authorization request message to a transaction processing system, and wherein the authorization request message is evaluated in view of information from an issuer processor or a healthcare processor; and
code for receiving a response message in response to the eligibility authorization request message.

11. The medium of claim 10 wherein the authorization request message is routed from the transaction processing system to the healthcare processor via the issuer processor.

12. The medium of claim 10 further comprising code for adding data to a data field to indicate that the eligibility authorization request message relates to a non-financial transaction.

13. The medium of claim 10 wherein the healthcare processor is operated by an insurance carrier or entity on behalf of the insurance carrier.

14. The medium of claim 10 wherein the response message relates to whether or not the patient is eligible for a healthcare related good or service.

15. The medium of claim 10 wherein the patient information is at least in part obtained from a from a portable consumer device, wherein the portable consumer device is in the form of a card or another portable consumer device.

16. The medium of claim 10 further comprising code for receiving a service code at the terminal.

17. A terminal comprising the computer readable medium of claim 10.

18. A system comprising the computer readable medium of claim 10.

19. A method comprising:
receiving patient information comprising a patient identification number at a terminal operated by a healthcare provider, wherein the patient information is stored or displayed in a portable consumer device in the form of a card;
creating a non-financial eligibility authorization request message which relates to healthcare insurance coverage using the patient information, wherein creating the eligibility authorization request message comprises adding data to a data field to indicate that the authorization request message relates to a non-financial eligibility transaction;
sending the eligibility authorization request message to an acquirer processor, wherein the acquirer processor sends the authorization request message to a transaction processing system, and an issuer processor, and then optionally to a healthcare processor; and
receiving a response message from the healthcare processor or the issuer processor.

20. The method of claim 19 further comprising: displaying or printing information relating to the response message at the terminal
